(19) United States
(12) Patent Application Publication
(10) Pub. No.: US 2007/0198468 A1
(43) Pub. Date: Aug. 23, 2007

(54) Digital data broadcasting

(76) Inventor: Adam L. Berger, Pittsburgh, PA (US)

Correspondence Address: FISH & RICHARDSON PC, P.O. BOX 1022, MINNEAPOLIS, MN, 55440-1022, US

(21) Appl. No.: 11/362,447

(22) Filed: Feb. 23, 2006

(51) Int. Cl. G06F 17/30

(52) U.S. Cl. 707/2

(57) ABSTRACT

For each content item of a set of content items to be transmitted, a transmission schedule includes times to transmit the content item, and the transmission schedule, a descriptor file describing the content item, and the content item are prepared for transmitting.

### BACKGROUND

This description relates to digital data broadcasting.

When digital data in the form of media content, for example, is delivered over the Internet, the content is stored at a source (a single server or a distributed set of servers) and is requested, often using HTTP, by an IP-enabled device, e.g., a PC, PDA, cell phone, or set-top box. The device may play the content as it is delivered (“streaming” content), or it may store the content as a file for later playout (“clipcast” content). Each file delivery is executed using point-to-point communication between one sender and one receiver.

A new delivery mechanism for media objects, called broadcast networks (e.g., DVB-H, DMB, ISDB-T, FLO), deliver content, not through the routers, switches, and other infrastructure that comprise the Internet, but by satellite and terrestrial transmitters that use proprietary spectrum. Such broadcasting delivers files from one server (or a set of distributed servers) to user devices using a fixed-capacity, one-to-many channel (e.g., a slice of radio frequency, RF, spectrum) rather than a traditional packet-switched network. A single (or distributed) server sends packets of the multimedia material into the channel, without knowing who might be receiving the transmission, just as with traditional analog broadcast media. As many parties as want to receive the transmission may do so without engaging in point-to-point communication with, or having any effect on, the transmitting server.

The marginal cost to an IP broadcaster of adding another recipient is zero. In addition, the marginal cost of adding more content to be broadcast, after acquiring it, is zero if there's more room in the channel and is essentially infinite if there isn't more room.

### SUMMARY

In general, in one aspect, for each content item of a set of content items to be transmitted, a transmission schedule includes times to transmit the content item, and the transmission schedule, a descriptor file describing the content item, and the content item are prepared for transmitting.

Some implementations may include one or more of the following features. Preparing for transmitting includes preparing for transmitting on a one-way channel. Preparing includes adding the content item to a queue of content items to be transmitted together. Adding the content item to a queue of content items includes determining that a content item matches another content item in the queue, and removing the other content item from the queue. The descriptor file is prepared to be transmitted before each time the content item is transmitted. Transmitting all content items in the queue repeatedly. Preparing the queue to be transmitted in a first stream, and the descriptor file and transmission schedule to be transmitted in a second stream. The times to transmit the content item include a final time that will occur a predetermined amount of time before an expiration time of the content item. The times to transmit the content item include times to transmit pieces of the content item. Preparing to stop the transmitting of the content item before the scheduled last time to transmit the content item. Enabling a party to choose a number of times that the content item will be scheduled to be transmitted. Adding information in a received information file to the descriptor file, and adding information from the received information file to the schedule file.

Including times in the transmission schedule includes adding information to the schedule file identifying a subset of a population that should accept the transmitting of the content item. The set of content items includes one or more of high-resolution video files, low-resolution video files, audio files, images, ringtones, data files, and computer programs. Adding the content item to a position in a queue of content items. Adding to the descriptor file information about each content item's position in the queue, the transmission schedule including information about a next time the queue will be transmitted. transmitting descriptor files corresponding to all content items in the queue, and transmitting each content item in the queue in turn. Repeatedly, while transmitting the content items, assigning content items to a next cycle of the queue by doing one or more of removing a content item in the queue from the next cycle, adding a new content item not in the queue to the next cycle, and replacing a content item in the queue with a new content item in the next cycle, for each new content item, storing information about the new content item and the new content item's position in the next cycle in a description content item corresponding to the new content item, transmitting the description files corresponding to the content items in the next cycle, and transmitting each of the content items in the next cycle in turn. Transmitting an indication of when transmission of a next cycle of the queue will begin.

In general, in one aspect, content items from a set of content items are assigned to positions in a queue. For each content item, information about the content item and the content item's position in the queue is stored in a schedule file corresponding to the content item. Repeatedly, the schedule files corresponding to the content items in the queue are transmitted, and each of the content items in the queue are transmitted in turn. While the content items are being transmitted, content items are assigned to a next cycle of the queue by doing one or more of removing a content item in the queue from the next cycle, adding a new content item not in the queue to the next cycle, and replacing a content item in the queue with a new content item in the next cycle. For each new content item, information about the new content item and the new content item's position in the next cycle is stored in a schedule file corresponding to the new content item, the schedule files corresponding to the content items in the next cycle are transmitted, and each of the content items in the next cycle are transmitted in turn.

In general, in one aspect, a file to transmit and information describing the file are received, a time is assigned in a schedule to transmit the file, a second file is created from the information describing the file and the assigned time, the second file is transmitted, and at the assigned time, the file is transmitted.

Some implementations may include one or more of the following features. Assigning a time includes assigning the file to a position in a queue of files. Transmitting the file includes transmitting the queue of files. The information includes one or more of a show title, a series title, a category, a type, and a flag. Assigning a time in a schedule includes comparing a description of the file to descriptions of files already scheduled, if a condition is met, removing an already scheduled file from the schedule, determining the size of the file, a number of times to transmit the file, a time by which the last transmission must be completed, and times available for transmissions in the schedule, and assigning an available time for a first transmission of the file, and available times for subsequent transmissions of the file. Assigning a time in a schedule includes matching the file with files already scheduled, if a condition is met, removing already scheduled files from the schedule, determining the size of the file, assigning the file to a position in a repeating queue of files, storing information about the file and its position in the queue in a second file.

In general, in one aspect, a schedule indicating a time when a content item will be transmitted on a one-way channel, and a description of the content item, is received at a user device and the user device is prepared to receive the content item at the time when it is transmitted on the one-way channel.

Some implementations may include one or more of the following features. Deleting a stored file on the user device if a condition is met in connection with the transmission of the content item. The condition is met if a description of a received content item matches a description of the stored file. Maintaining a list on the user device of content items available to be received. Removing a content item from the list if the file has been received. Downloading a first part of the content item at a first time, and downloading a second part of a content item at a second time. Maintaining a list of content items to be received and times to receive them. Maintaining a list of content items to be received and times to receive them by receiving a schedule corresponding to a content item, comparing information in the schedule to information in a subscription policy, and if a condition is met, adding an identification of the content item and a time to receive the content item to the list. Receiving the schedule at the beginning of a cycle of a queue of content items that includes the content item.

The condition is met if a description of the content item matches a description in the subscription policy. The condition is met if a description of the content item indicates that the content item is required to be received. Removing a content item from the list after the content item has been downloaded. Maintaining a list of content items that have been received. Periodically determining if a content item has been deleted from storage, and remove such a content item from the list of content items that have been received. Depending on a condition of a first indicator in the schedule, receiving the corresponding content item, and depending on a condition of a second indicator in the schedule, not adding the content item to the list of content items available to the user. Before presenting a received content item selected by a user, presenting the content item received as a result of the first indicator. The content item received due to the first indicator includes an advertisement. Maintaining a unique subscription file for each of one or more users. Displaying to a user a list of content items available to be received, and an indication whether a content item in the list is selected to be received.

Creating the list of content items by, for each schedule the device has received, if the schedule includes a category of a corresponding content item, adding the category to the list, if the schedule includes a series of the corresponding content items, adding the series to the list, and if the schedule does not include a series of the corresponding content items, adding titles of the content items to the list. Not receiving a content item if a size of the item would cause the device to exceed its capacity. When receiving a content item or a description file, comparing an ID in the content item to an ID in the schedule corresponding to the item, and if the ID does not match, stopping receiving the file. Enabling a user to do one or more of: view a list of stored items, delete stored items, assign categories to stored items, assign priorities to stored items, and add information about stored items. Enabling a user to specify one or more of how to store downloaded content items, where to store downloaded content items, how often to receive information about when content items will be transmitted, and a maximum size content item to download. The user is a user of the device. The user is a provider of the transmissions. Receiving the schedule during a transmission of a repeating queue of schedules, and, at a time indicated in the schedule, receiving the description file and the content item corresponding to the schedule. Storing a copy of a schedule that includes a time of a final transmission of a content item, and when the last transmission has begun, removing the content item from a list of files available to be received.

Periodically changing modes to receive schedules in the queue of schedules, for each schedule in the queue of schedules, comparing information in the schedule to information in a list of items to be received, if information in a schedule matches information in the list, storing a time when the corresponding content item will be transmitted, until the stored time, changing modes to conserve power, and at the stored time, changing modes to receive the corresponding content item. Receiving an indication of when a repeating queue of content items will start a next cycle, at the indicated time, receiving schedules for the items that are in the queue, at a time indicated in a received schedule, receiving a description file and a content item when they are broadcast as part of the queue. Periodically changing modes to receive the indication, until the time when the next cycle will start, changing modes to conserve power, at the time when the cycle will start, changing modes to receive schedules, receiving a schedule, storing a time indicated in the schedule that a content item will be transmitted in the cycle, until the stored time, changing modes to conserve power, at the stored time, changing mode to receive a content item, after receiving the content item, changing modes to conserve power.

In general, in one aspect, for each content item of a set of content items to be transmitted, a number of times to transmit the content item is included in a transmission schedule, the number of times being determined by a provider of the content item, and the transmission schedule, a descriptor file describing the content item, and the content item are prepared for transmitting.

In general, in one aspect, for each content item of a set of content items to be transmitted, a number of times to transmit the content item is included in a transmission schedule, the number of times including a final time that is a predetermined amount of time before an expiration time of the content item, and the transmission schedule, a descriptor file describing the content item, and the content item are prepared for transmitting.

In general, in one aspect, for each content item of a set of content items to be transmitted, an information file corresponding to the content item is received, a number of times to transmit the content item is included in a transmission schedule, information in the information file is added to a descriptor file describing the content item, other information from the information file is add to a schedule, the times to transmit the content item are added to the schedule, and the schedule, the descriptor file, and the content item are prepared for transmitting.

In general, in one aspect, for each content item of a set of content items to be transmitted, an information file corresponding to the content item is received, a unique identifier corresponding to the content item and information in the information file is created, the unique identifier is added to a descriptor file describing the content item.

In general, in one aspect, for each content item of a set of content items to be transmitted, the content item is added to a position in a queue of content items, the position of the content item in the queue is added to a schedule, the schedule is added to a queue of schedules, and the queue of schedules and the queue of content items are simultaneously transmitted.

In general, in one aspect, content items to be broadcast to user devices are organized into groups that depend on at least one of the length of the items and the rate at which the items become stale to users of the devices, and transmission of different groups to the user devices is controlled in accordance with different transmission routines.

In general, in one aspect, a file that contains a content item to be broadcast to user devices includes a lifetime value that is indicative of when the file is expected to become stale to users of the devices.

In general, in one aspect, a content item is scheduled for repeated broadcast to user devices, and a glide interval is established representing a time after a final broadcast of an item that is sufficiently ahead of a lifetime associated with the content item to permit the user to use the content item after receipt of the final broadcast and before the lifetime has expired.

In general, in one aspect, content items are updated in a recirculating set of content items to be broadcast to user devices while content items in the recirculating set are being broadcast to user devices.

In general, in one aspect, metadata associated with content items to be broadcast to user device is transmitted to the user devices, the metadata being broadcast in at least two separate portions, one portion including information to enable user devices to determine whether and when to receive one or more of the content items, the other portion containing additional descriptive information about the content items.

In general, in one aspect, pieces of a transmitted content item are received at user devices at different times, when at least one additional piece must be received in order to have a complete content item, a time at which the one additional piece will be transmitted is tracked at the user devices, and the complete content item is assembled at the user devices when all of the pieces have been received, for presentation to the users of the devices.

In general, in one aspect, a user device that is configured to receive scheduling information about content items that are to be broadcast at times not controlled by the device is enabled to save power by altering its power mode according to whether a broadcast of a desired content item is occurring.

Other advantages and features will be apparent from the description and the claims.

### DESCRIPTION

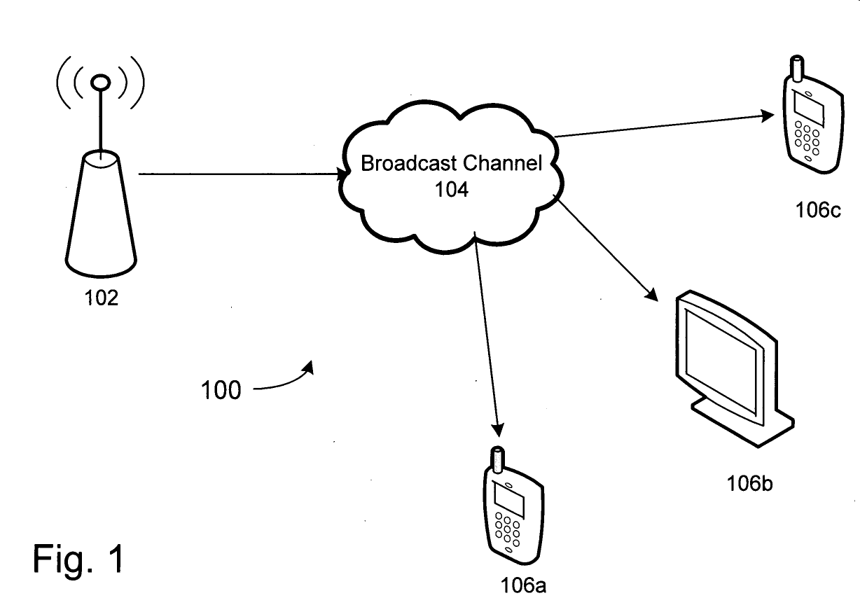

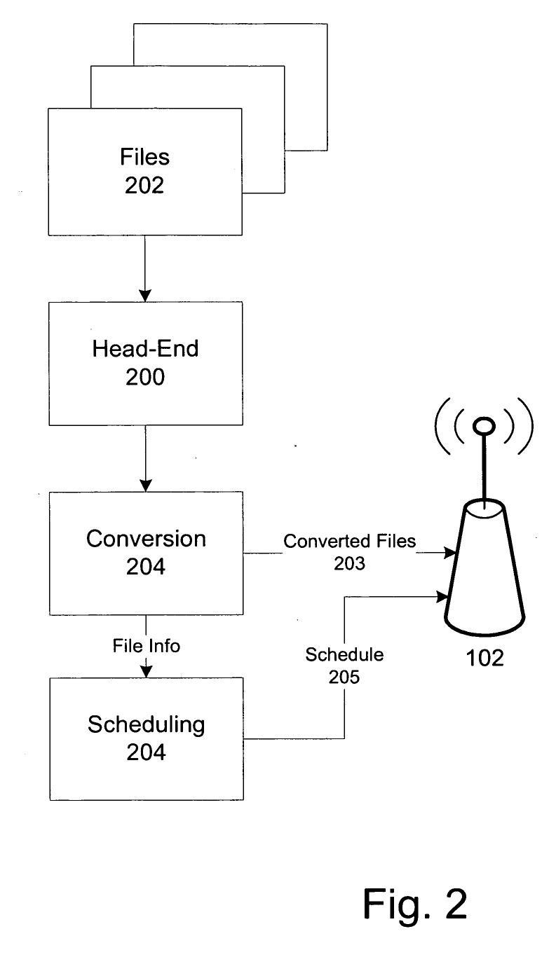

FIGS. 1 and 2 are block diagrams.

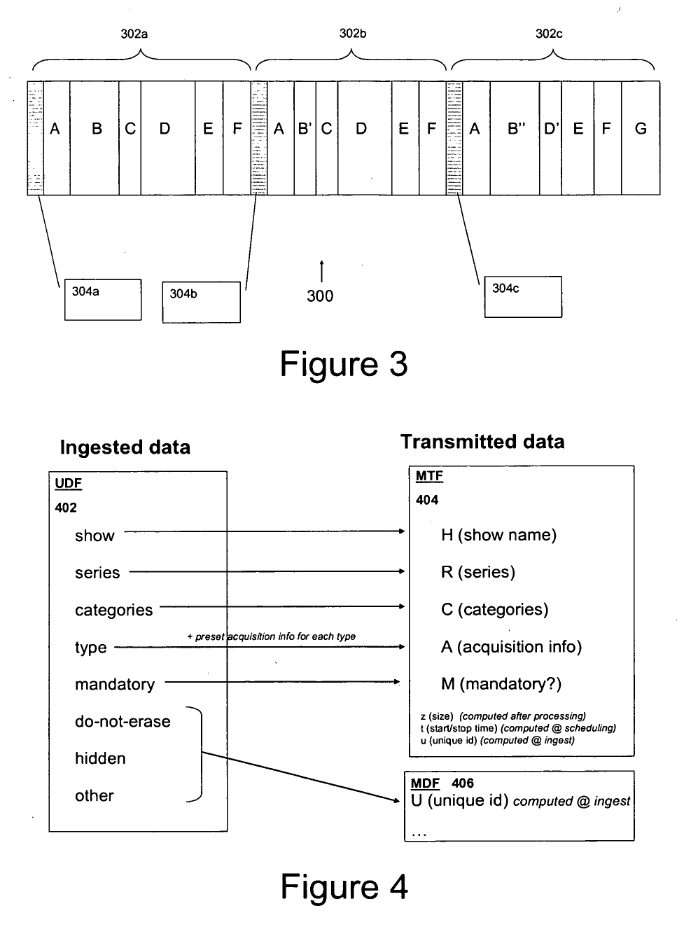

FIG. 3 is a schematic diagram of a file sequence.

FIG. 4 is a mapping diagram.

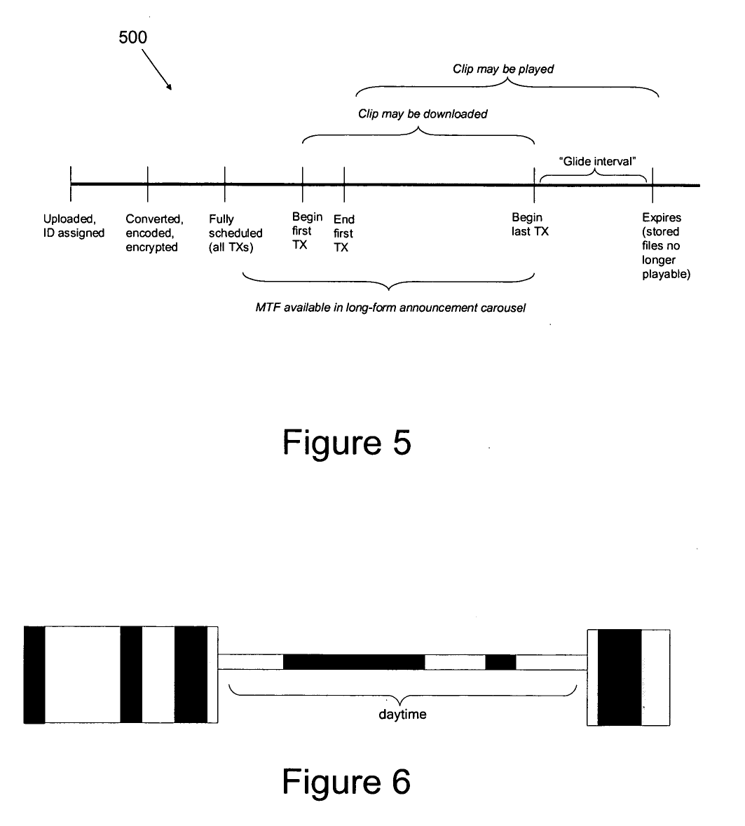

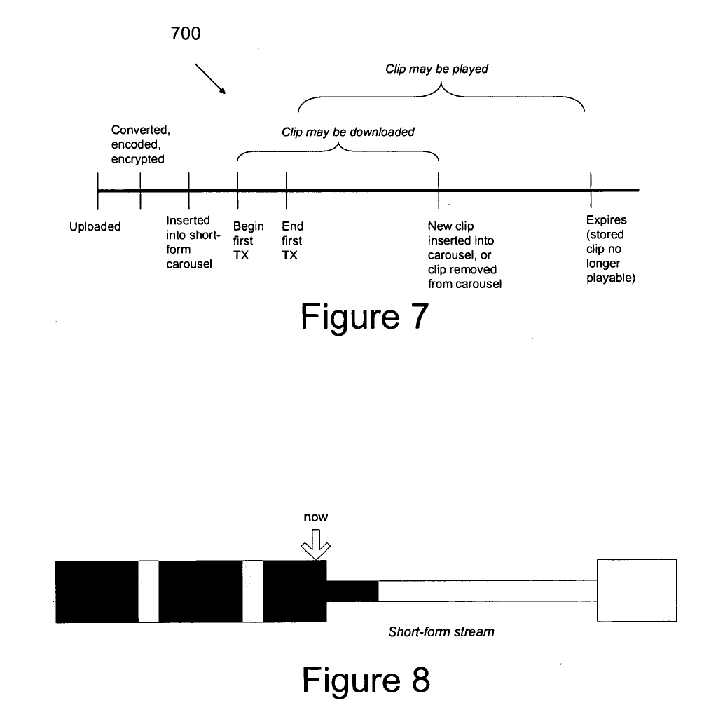

FIGS. 5 and 7 are time lines for a digital content broadcast.

FIG. 6 and 8 are time charts.

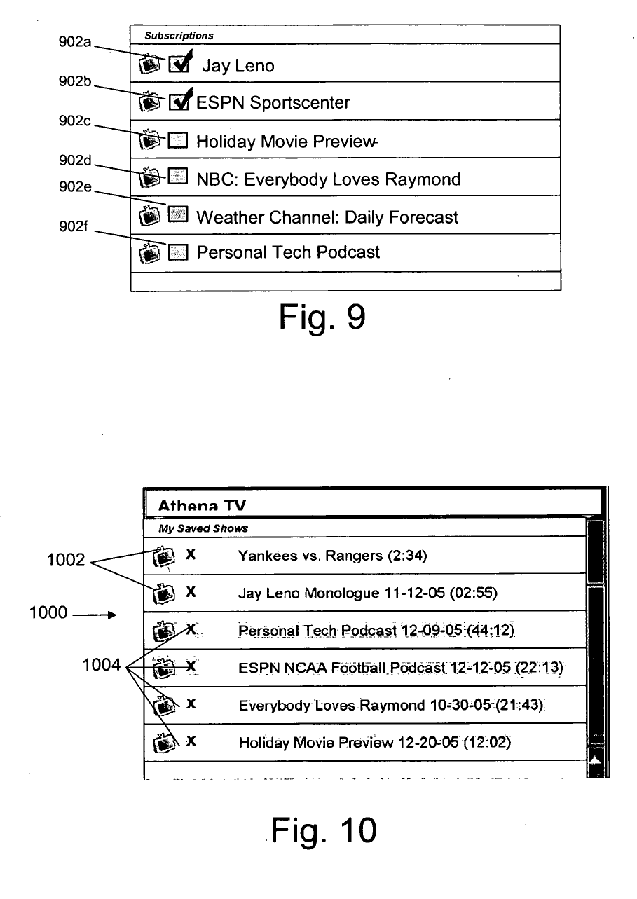

FIGS. 9 and 10 are screen shots.

As shown in FIG. 1, in an example of a digital broadcast system 100, a single broadcasting center (also called the transmitting head end) 102 transmits IP packets through a broadcast channel 104. Any and every handheld, desktop, or other device, or client 106a, 106b, or 106c that is within range of the broadcasting center 102 and is equipped to receive the broadcast can receive the packets. Unlike the operation of a point-to-point network, such as the Internet, the transmitting head-end 102 is unaware of which and how many, if any, devices are receiving its transmission.

To produce the broadcast, as shown in FIG. 2, media (content) files 202 (for example, video clips, audio clips, or other items) are ingested at a head-end 200 and subjected to a conversion process 204 that may include encoding and/or encryption. Information about the files is passed to a scheduling process 206 that schedules the files 202 to be broadcast within the constraints of the available capacity. The converted files 203 are transmitted through the broadcast channel 104 (FIG. 1) by the broadcasting center 102 according to a schedule 205 generated by the scheduling process. Recipient devices 106 (FIG. 1) may download, store, and later present these multimedia items to users. The files broadcast and downloaded could also be any kind of digital material other than multimedia files, for example, text documents, images, software, ring tones, Java applications, and others.

Each of the files that is scheduled and ready to be sent over the broadcast channel may be organized as a discrete unit that we call a mediacast. In some implementations, a mediacast is one of two kinds: long-form and short-form. The two have different characteristics and are treated differently.

A long-form mediacast is typically longer than ten minutes and often much longer, on the order of 30 minutes to 3 hours. If the long-form mediacast is episodic, the user may retain each prior episode, or some number of prior episodes, when a next episode arrives. A long-form mediacast often is not time-sensitive and may be relevant days or even weeks after it is initially ingested by the server. Examples of long-form mediacasts include feature films, television serials or episodic programming, children's programming, documentaries, or comedy performances.

A short-form mediacast is typically shorter than ten minutes and usually not even half that. It may be episodic, but the user will typically delete a prior episode when the next episode arrives. The content of a short-form mediacast goes stale quickly and typically is only relevant for hours after it is ingested by the server. Examples include news, weather, and sports reports, or other topical entertainment that loses its viewer appeal within minutes or hours after initial production.

We use the word lifetime to mean, for example, the period during which a mediacast has relevance or utility to users. Lifetime can also mean the time that the broadcast schedule sets as the final time when the mediacast will be usable. The lifetime of a file is determined by business rules set by the content owner. For example, Disney may wish to have their files expire after a week, but Turner may wish theirs to last a month. The lifetime may be contained in a value that is stored with the file when it is ingested. Thus, a mediacast file may be annotated with an expiration date after which it may no longer be played on a client (we sometimes refer to the receiving devices as clients). Because the recipient devices 106 may be low-power devices (e.g., cell phones) that cannot practically monitor the broadcast channel for new mediacasts at all times, the broadcasting center 102 provides a schedule signal indicative of when one or more mediacasts are going to be broadcast. This enables the recipient devices to selectively tune in or tune out based on the schedule and a user's preferences.

For business reasons, a long-form file (we sometimes refer to a mediacast as simply a file) may have to be transmitted more than once (say N times) to increase the probability that a receiver will be able to receive it in a later transmission, for example, if the receiver is off or busy during an earlier transmission. The number N may be negotiated between the owner of the broadcast network and the owner of the rights in the mediacast material on a per-file basis. A likely range for N is one to five transmissions for a typical mediacast.

By virtue of their different characteristics, long form and short form mediacasts may be scheduled differently for broadcast.

A long-form file can be scheduled for transmission once and for all at the time that the file is ingested. The scheduling is done by a process that attempts to achieve a variety of goals. One objective may be to spread out the transmissions over the lifetime of the clip (we sometimes refer to a file as a clip). The last transmission should occur, for example, a fixed amount of time, referred to as a glide interval, before the lifetime of the clip expires, to assure that recipients get a chance to use it before its lifetime expires.

Short-form files are initially broadcast as soon as possible upon ingestion, because the content of a short-form file typically has a short lifetime.

No files (of either form) can be scheduled before being ingested. This constraint exists for a few reasons. One is to ensure that the file is always available to be broadcast when it is scheduled. The second reason is that the size of a file is not, in general, known by the server until the clip is ingested; that is, there is no pre-delivery signaling from the content provider of the size of a forthcoming file.

In order to enforce the schedule effectively, including the lifetime of files and the glide times, clocks on the server and clients are assumed to be synchronized, for example, by an external mechanism. (In a DVB-H broadcast system, for example, the time may be carried in the Time Date Table (TDT).)

In some examples, the files are protected using a content protection scheme like Windows Media DRM (digital rights management). Clients must then have appropriate DRM functionality to access the files. These protection schemes can also enforce business rules such as expiration dates on a file, allowing a fixed number of copies of the file, and others.

The files (mediacasts) and related information, for example, expiration date, actors, rating, etc., are broadcast as streams.

The broadcast channel is typically organized as a multiplex. That is, the network is organized in parallel sub-channels. For example, in DVB-H broadcast networks, each channel corresponds to a multicast IP address and a port. A stream is a sequence of bits conveyed along a single sub-channel.

By analogy, a stream can be viewed as a conveyer belt, and mediacast files as widgets on the belt. The entire broadcast channel is like an assembly line, with many parallel conveyer belts (the sub-channels) of varying widths (bandwidths). A wider belt conveys widgets (content) at a higher net rate than a narrower one.

The capacity (bandwidth) of a sub-channel may be fixed or (because of business goals) may be made narrower and wider depending on the time of day. For example, a higher bit-rate may be assigned to mediacast delivery at night when there is less demand on the network from other data traffic (e.g. live TV and radio services). The system described assumes that the future instantaneous bit-rate associated with a stream is known in advance of scheduling.

In some examples, files are arranged in carousels to be carried as streams on the sub-channels. As shown in FIG. 3, a carousel 300 includes a repeated sequence 302 of files A, B, C, one after another, that is transmitted repeatedly as a loop in one of the streams. Three repetitions of the loop are shown. After each loop (i.e., cycle), files in the carousel may be updated, removed, or added. For example, a cycle 302a consists of files A, B, C, D, E, and F. In a second cycle 302b, file B is replaced by file B′. In a third cycle 302c, file B′ is replaced by file B″, file D is replaced by file D′, file C is removed, and a file G is added. In between each cycle, additional information 304a, 304b, 304c is transmitted, including a mediacast triage file (MTF), described below.

Streams can be used to transmit mediacast files or other information files, such as a file that contains a schedule of mediacast files to be broadcast. In some examples, the mediacast system uses four streams: 1. A long-form stream conveys only long-form mediacast files. 2. A short-form stream conveys a carousel of short-form mediacast files. 3. A long-form announcement stream conveys a carousel of announcements of future long-form mediacasts. 4. A short-form heartbeat stream conveys a carousel containing a single file that bears a start time for the next short-form carousel. Alternatively, the data conveyed by the short-form heartbeat stream could be conveyed to the client in other ways, e.g., by inclusion in another stream or embedded elsewhere in the broadcast multiplex.

Each mediacast file includes meta-information describing the file contents, how the file should be treated by the head end (we sometimes refer to the broadcasting center as the head end) and by the client, and other information. Each ingested mediacast includes a metadata file which we refer to as an Upload Descriptor File (UDF), supplied at the time of ingestion by the provider of the mediacast file. After being received at the head-end, the UDF is broken into two components. We call these components a mediacast triage file (MTF) and a mediacast descriptor file (MDF). Both are included in a transmitted stream, along with, though not necessarily at the same time as, the mediacast file itself.

FIG. 4 shows one example of how data from a UDF 402 is divided into an MTF 404 and an MDF 406. The UDF 402 contains available information about a mediacast file. The MTF 404 contains just enough information to enable clients to “triage” the mediacast, that is, to determine whether to download the mediacast file to which the MTF pertains and when to do so. The MDF file 406 contains a richer description of the mediacast file, such as information that can be used in a client application's menu screen to describe the content of the file. This information contains a unique identifier u that is computed when the UDF is ingested at the head-end.

In some examples, the provider of a video file for broadcast creates a UDF for that file containing at least a minimum set of information. This information includes such fields as ‘show,’ which is the name of the video, and ‘categories,’ which identifies which packages the video is a member of, for example, sports, news, or cartoons. Other fields in the UDF may include ‘mandatory,’ which tells the client that it must download the video if possible, and ‘do-not-erase,’ which tells the client not to let the user erase the file. A ‘hidden’ field tells the client to hide the file from the list of files available to the user. An ‘other’ field may be provided to allow the provider to include additional information, such as the original airing date, the actors, the MPAA rating, and other descriptive information. This information is formatted in “binding=value” pairs to be used by the client in a menu application, for example. An example set of fields is shown in Table 1.

TABLE 1

| | |
|---|---|
| Field | Value |

| show | | SpongeBob Squarepants episode 283 |
|---|---|---|
| categories | | cartoon kids family |
| other | content owner | Nickelodeon |
| | original air date | Oct. 12, 2003 |

In some examples, an additional field is a ‘retailer key.’ Clients may be configured to download only files having a retailer key matching the one on the device, and to ignore other files. For example, a phone sold through one wireless carrier will have a retailer key corresponding to that wireless carrier. In this way, mediacasts may be targeted to a specific subpopulation among all the receivers, e.g., just those phones sold through a specific wireless carrier.

The purpose of the MTF is to signal future delivery of a mediacast file. An MTF may be in a ‘field=value’ format. There is an MTF corresponding to every mediacast file. Fields in the MTF include ‘show (H)’, the name of file, ‘series (R),’ and ‘categories (C),’ which are inherited from corresponding fields in the ingested UDF. If a video (we sometimes refer to a mediacast or file or clip as simply a video in some examples) is an episode of a series, the ‘series’ field contains the name of the series, e.g., “Lost” or “Jay Leno.” For videos that are not part of a series, this field would be blank. As in the UDF, the ‘categories’ field is a list of packages that the video belongs to, for clients to match against their stored subscription policy.

Other fields include ‘acquisition information (A)’, which lists the multicast IP address and port where the file will appear and be accessible to the client device, ‘size (Z),’ which lists the size of the mediacast file in bytes, and ‘transmit start/stop time (T),’ which lists the time the mediacast file will be transmitted. In some examples, the values in this field are specified as decimal representations of NTP (network time protocol) time values, in seconds. To convert these values to UNIX time, the number 2208988800 is subtracted. The syntax for this field is [start time of next transmit] [stop time of next transmit] [start time of 2^{nd} transmit] [stop time of 2^{nd} transmit] [start time of 3^{rd} transmit] etc. There is only one MTF for a given mediacast file, even if that file is to be transmitted multiple times. An example set of fields is shown in table 2, in which the single-character field names are used to minimize the size of the file.

TABLE 2

| Field | Value |
|---|---|
| H | Jay Leno Nov. 5, 2005 |
| R | Jay Leno |
| U | 1349 |
| C | Comedy Talk NBC |
| A | 124.98.32.11 34 |
| Z | 230451233 |
| T | 2211988800 2215988800 |
| | 2217988800 2218988800 |
| | 2311988800 2335988800 |

The MTF is called a triage file because it contains just the bare information required for a client to make a yes/no decision on whether to download the file. To contrast, the MDF contains elaborative information, of relevance to a client that has already downloaded the mediacast file, e.g., actors, MPAA rating, original air date, copyright information, and hyperlinks (to web site, etc.). One use of this information is to populate a menu/service guide provided by the client.

In some examples, as shown in FIG. 5, during a life-cycle 500 of a long-form mediacast, first, the clip is ingested (uploaded), along with an Upload Descriptor File (UDF). Next, the clip is assigned a unique identifier (U) by the system. This ID can be an integer, or any other data value, as dictated by the needs of the system. The video clip is then processed, including encoding (for example, into a different video format), encrypting, and applying forward error correction encoding. An MDF is created from the UDF and the unique ID. If the ingested clip's ‘show’ value matches that of an already-scheduled clip, all future transmissions of the scheduled clip are removed from the schedule, clearing space in the long-form stream for the new clip. A number, N, of transmissions of the clip are scheduled, as evenly as possible, between now and the last possible time (the lifetime time minus the glide interval), according to availability. If a clip cannot be scheduled, an exception is raised. On the timeline of FIG. 5, the first and last transmission are scheduled as indicated, and any additional transmissions are scheduled in between those transmissions, possibly inter-mixed with transmissions of other clips, not shown.

After a clip is scheduled, an MTF for the clip is generated, using as input the UDF and the scheduled transmit times. This single MTF contains all the scheduled transmission times for the clip. The MTF is then inserted into the long-form announcement carousel and will live in the carousel until some time before the final transmission of this clip. The MDF and the clip are transmitted, one after the other (see ‘file delimiters,’ below), as scheduled.

At some fixed period of time before the final transmission begins, the MTF is removed from the long-form announcement carousel. An administrative user may manually remove a long-form file from the system, even after it is scheduled. The scheduled slot(s) in the long-form stream will then be available for other transmissions. The remaining processing of the clip is handled by each client that chooses to receive it. Any client that has a cached MTF will recognize when the final transmission has begun, and will behave accordingly (i.e., by removing the file from a ‘clips you can download’ panel). Eventually, any DRM privileges on the file may expire, and clients will delete any copies they have stored.

Each individual transmission of a mediacast does not need to include the entire file. A long clip can be broken up into pieces and the pieces scheduled separately, to accommodate existing scheduling constraints, e.g., if there is no available slot large enough for the whole file. Sending a file in pieces is facilitated by using a fountain-based forward error correction technology such as the “Raptor” product available from Digital Fountain of Fremont, Calif. In this case, the number of “transmit windows” for a clip may exceed the number of transmissions of the clip scheduled. A client can elect to download some pieces of a split file at one time and download other pieces during another transmission. The client could proceed that way for various reasons, when a download is interrupted by user action or by low battery power, for example. Thus, N should not interpreted as “number of transmissions” of the whole clip. Rather, N represents a multiplicative factor. For example, N=3 means the head-end will transmit 3 times the number of bytes for this file than it would for N=1.

As shown in FIG. 6, a long-form stream is at least partially scheduled well into the future. The black regions indicate scheduled transmissions, while the white regions indicate available space in the stream. In this example, the stream is narrower during the day and wider at night, allowing a given file to be broadcast in a shorter amount of time at night.

In some examples, as shown in FIG. 7, a somewhat different series 700 of events occurs in the life-cycle of a short-form mediacast. First, as with a long-form mediacast, a clip is ingested along with an Upload Descriptor File (UDF), the clip is assigned a unique ID U, the clip is processed, and an MDF is created from the UDF and the unique id U. From this point on, the processing is different.

The mediacast file is inserted into the next cycle of the short-form carousel, that is, the current carousel cycle will run to completion, and the new file will appear in the next cycle. If the ingested clip's ‘show’ value matches the ‘show’ value of a clip currently on the short-form carousel, the older clip is replaced on the carousel by this new clip. Each time the carousel cycles, each clip is broadcast in sequence with the other clips on the carousel. The clip stays in the carousel until one of the following occurs: an administrative user manually removes it, its expiration date is reached, and the head-end automatically removes it from the carousel, or a new clip with the same ‘show’ value replaces it.

Referring back to FIG. 3, a short-form stream contains repeating cycles 302a, 303b, and 303c of a carousel. The first cycle 302a has six clips, A through F. By the time the carousel comes back to the beginning for the second cycle 302b, clip B has been updated to B′ (same ‘show’ value, different clip). In the third cycle 302c, B has again been updated and so has D. Meanwhile, clip C has disappeared (by manual deletion or expiration), and clip G has been added. The MTF files for all of the files in each cycle are all broadcast at the beginning of each cycle in blocks 304a, b, and c. This helps to reduce power consumption by the receiving devices by allowing them to tune in at the beginning of the cycle, download all the MTF files, and then conserve power by not receiving any more of the transmission until the clips they want are being transmitted, based on the information in the MTF files. Similarly, the heartbeat stream allows receiving devices to conserve power by requiring only a short download to inform them when the next cycle of the carousel will begin, and allowing them to otherwise remain dormant until that time.

As shown in FIG. 8, in contrast to long-form streams, a short-form stream is scheduled only a short time in advance, for example, just one cycle in advance. That is, the black region representing the current broadcasting cycle of the carousel is scheduled to continue, but after that, nothing is scheduled. The next cycle of the carousel will come after the current one, in the currently white area, but its content will not be set until shortly before it begins transmission.

While a given cycle X of the carousel is being transmitted, a queue for cycle X+1 is created at the head-end using the following process. First, all non-expired clips from cycle X are added to the queue. Next, all newly registered clips are added to the queue. As mentioned above, any new clip with the same ‘show’ value as an old clip replaces the old clip in the carousel. Other new clips are added without replacing other clips. When cycle X has finished, cycle X+1 is “committed,” meaning that no more mediacasts can be added to this cycle. Then the queue of files for cycle X+1is written (along with associated MTF and MDF files) into a buffer, which could be memory or file-based, that contains the data to be sent on the short-form mediacast stream. In some examples, all the MTFs are written first, one after another. Then, the Mediacast files are written, each prefaced by its MDF. In other words, the queue has the form:

[MTF1 MTF2 MTF3 . . . MTFn] [MDF1 FILE1MDF2 FILE2 . . . MDFn FILEn]

Note that the ‘t’ fields (start and stop times) in the MTF were given placeholder values when the MTF was created from the UDF. Now, after the full carousel buffer has been fixed, the actual transmit start/stop times can be calculated, based on the stream bitrate and file sizes, and written into the MTFs. Now that the carousel buffer is completely specified and written, the buffer for cycle X+1 is sent for transmission. The start time of the next cycle is now calculated, and provided to the signaling system that transmits this information over the broadcast stream (for example, the aforementioned heartbeat carousel, which repeatedly transmits that single piece of information).

The head-end puts files into a stream by creating a delimiter before each file, for example,

*KEY*

[file]

Where KEY is one of MTF [clip uid], MDF [clip uid], or mediacast [clip uid].

In some examples, the client device maintains a subscription file for each user. Table 3 shows an example file in which keywords Categories, Series, and Show are each followed by corresponding values indicating the user's subscription choices. The subscriptions shown in table 3 indicate that the user subscribes to any shows in the Comedy, Sports, or Hollywood Entertainment categories, and specifically the series “Lost” and “Desperate Housewives,” as well as the one-time shows “Finding Nemo” and “Churchill Documentary.” The file can be modified by an application running on the client through a subscription management module. This module presents to the user a menu of possible shows, series, and categories for selection, as shown in FIG. 9. The toggle checkboxes 902a through 902f allow the user to visually distinguish subscribed-to from not-subscribed-to programs, for example the checkboxes 902a and 902b indicate that the user has subscribed to “Jay Leno” and “ESPN Sportscenter.” In some examples, users must subscribe to a series, not to individual episodes.

TABLE 3

*CATEGORIES*
Comedy
Sports
Hollywood Entertainment
*SERIES*
Lost
Desperate Housewives
*SHOWS*
Finding Nemo
Churchill Documentary

In some examples, the list of available subscriptions to present to the user is created as follows. The client software consults the MTFs from the short-form and long-form carousels (from a cached copy of each list). A ‘series’ list is created containing all the series that appear in any MTF. A ‘show’ list is created of all the shows that appear in any MTF but that do not belong to a series. Similarly, a ‘category’ list contains all the categories that appear in any MTF.

In some examples, a client process regularly (e.g., once a day), checks for new long-form and short-form mediacasts matching the user's established subscription policy.

For long-form mediacasts, the client behaves as follows. First the client accesses the long-form announcement stream and examines each MTF in the carousel. For each one, such as the one shown in table 2 above, the client checks whether the MTF matches the stored subscription policy according, for example, to the matching algorithm explained below. If it does, a timer is set on the client to download the clip at the time(s) it will be broadcast. In the case where the terminal is a power-constrained device (e.g. cell phone), it may be required for the terminal to resume from a suspended power-save mode in order to download the clip.

Once a long-form file is successfully downloaded, future scheduled downloads for that show (MTFs with the same ‘H’ value) can be deleted from that client's planned downloads. Similarly, when a long-form file is deleted from the local storage, the client can check for the file in the subscription list under ‘show’ and delete it if it's still there. For example, if a user watched ‘Finding Nemo’ and then deleted it, he presumably does not want to download it again. (Note that this leaves series subscriptions intact since they match on ‘R’, not on ‘H.’) In some examples, the client application can't assume the user will only delete clips through the application, so it must monitor the mediacast file storage for files that “went missing,” i.e., were deleted manually, since the last check.

For short-form mediacasts, the client begins by obtaining the “time to next carousel start,” value (e.g., from the heartbeat carousel) and waits for the designated duration. The client then downloads the MTFs at the beginning of the short-form carousel and, for each one, checks whether the MTF matches the stored subscription policy. If it does, a timer is set on the client to download the clip at the time(s) it will be broadcast, as with the long-form mediacasts. The frequency at which the client wakes up and checks the schedule is policy-based—it can be a user-defined parameter or a fixed part of the client software.

For some types of clips, just as the head-end replaces an old mediacast file when a new mediacast file with the same ‘show’ value appears, the client might be configured to delete an old file when it downloads a newer version, for example, to avoid keeping yesterday's weather forecast when today's shows up.

In some examples, when the client compares an MTF to the subscription policy, the corresponding clip is a match if any of the following occur: the ‘H’ binding appears (exact lexical match) in the ‘Show’ subscription list; the ‘R’ binding appears in the ‘Series’ subscription list; or any elements of the ‘C’ binding appear in the ‘Categories’ subscription list. In addition, the client consults the ‘Z’ (size) field in the MTF and does not download the corresponding file if it is larger than a preset or user-configurable limit.

In some examples, U ids are included in both the MTF and MDF files and the stream itself to allow clients to validate, when reading an MDF and mediacast file, that the clip U id matches what they had expected based on the earlier MTF file.

In some examples, as shown in FIG. 10, a user interface application allows the user to view and manage (e.g., by deleting and reordering up/down and categorizing) his stored mediacast files by displaying a list of stored files, such as the “My Saved Shows” panel 1000. The icons 1002, 1004 to the left of each listed clip allow the user to view or delete the clip. In a system implementing a no-manual-erase flag, mediacasts annotated with such a flag would appear without a delete icon 1004 in the “My Saved Shows” panel 1000.

In some examples, the client must try to download mediacasts marked ‘mandatory.’ The intent of this flag is to support service announcements and advertisements. The flags ‘no-manual-erase’ and ‘hidden’ support these functions. Using these flags, the system can “force feed” certain mediacasts to clients, along with their subscription content. When the client has mandatory, hidden mediacasts stored, it can select among these mediacasts to play before playing the mediacast file requested by a user. Subjecting a user to commercial content (e.g., a “trailer”) before a selected show is a venerable tradition in movie theaters and (more recently) online video streaming services. The ads to be played can be selected at random or according to a multi-factored selection algorithm.

In some examples, if a client only receives part of a short-form mediacast, the client will delete the partial file and pretend none of it was ever received. The same behavior can be used for long-form mediacasts. Alternatively, the client can consult the MTF to see if there will be another transmission sometime in the future. If there isn't, then the clip can be deleted. If there is, then the client can wait for that transmission and build up the rest of the file by listening to that transmission. Using fountain-based encoding, the partially-saved file can be reused and only the missing portions downloaded on the subsequent transmission. In any case, clients that receive partial files will not show them in the menu until they are fully received.

Parameters to consider in implementing the system include the following.

At the head-end, the parameters could include the time before the last transmission when the long-form mediacast should be removed from the long-form announcement carousel; the length of time before clip expiration when the last transmission of the clip should be scheduled (glide interval); the largest size file or portion of a file to transmit; an acceptable range for the number of times to transmit a given clip; processing parameters including target encoding quality and amount of Raptor redundancy, based on a combination of technical capabilities of the system and business considerations of the head-end operator.

At the client, the parameters could include how and where to store local mediacast files; how often the client should refresh short-form content; how often the client should check long-form announcement carousel; the maximum value of ‘Z’ (file size) to avoid downloading over-threshold files (this may be dependent on the client storage capacity). These could be parameters configurable by the user or could be set by the service provider or the vendor of the client device, depending on technical and business relationships involved.

Channel requirements will vary for different uses of mediacast technology. In some examples, video may be transmitted at VC-1 “Main” Profile, Low-level (QVGA, 25 fps), which requires a rate of about 300 kb/s. In some cases, to transmit higher-quality video (e.g., for larger-screen devices), 4× capacity requirements (1.2 Mb/s) could be assumed.

For a long-form stream, for every hour of scheduled QVGA content (equivalently, 15 minutes of VGA content) per day, 12.5 kb/s total average daily stream capacity is required. For example, 20 hours of QVGA content daily (e.g., 2 feature-length movies at VGA, plus 4 hours of QVGA content) will require an average daily bitrate of 250 kb/s in order to keep up with the input.

The carousel-based short-form and announcement streams require a different approach. Here the issue isn't “keeping up” with the input, but how long a clip might have to wait between upload and transmission. In other words, how long is the carousel cycle? Table 4 gives some scenarios.

TABLE 4
Carousel-based stream capacity requirements

| | Unique information | Amt of time to |
|---|---|---|
| | per cycle | transmit full |
| Stream | (est., in bytes) | carousel (bytes/rate) |
| Short-form | 120 MB | ˜1:00 (@ 300 kb/s) |
| mediacast | | |
| stream | | |
| Long-form | 200 files = 200 | ˜30 s (@ 5 kb/s) |
| announcement | MTF files @ | |
| stream | 100 bytes each = 20 KB | |
| Short-form | 20 bytes | <<1 s (@ 1 kb/s) |
| heartbeat | | |
| stream | | |

Other embodiments are within the scope of the following claims.

What is claimed is:

1. A method comprising
for each content item of a set of content items to be transmitted, including in a transmission schedule times to transmit the content item, and
preparing the transmission schedule, a descriptor file describing the content item, and the content item for transmitting.

2. The method of claim 1 in which the preparing for transmitting comprises preparing for transmitting on a one-way channel.

3. The method of claim 1 in which preparing comprises adding the content item to a queue of content items to be transmitted together.

4. The method of claim 3 in which adding the content item to a queue of content items includes determining that a content item matches another content item in the queue, and removing the other content item from the queue.

5. The method of claim 1 in which the descriptor file is prepared to be transmitted before each time the content item is transmitted.

6. The method of claim 3 also including transmitting all content items in the queue repeatedly.

7. The method of claim 3 also including preparing the queue to be transmitted in a first stream, and the descriptor file and transmission schedule to be transmitted in a second stream.

8. The method of claim 1 in which the times to transmit the content item include a final time that will occur a predetermined amount of time before an expiration time of the content item.

9. The method of claim 1 in which the times to transmit the content item include times to transmit pieces of the content item.

10. The method of claim 8 also including preparing to stop the transmitting of the content item before the scheduled last time to transmit the content item.

11. The method of claim 1 also comprising enabling a party to choose a number of times that the content item will be scheduled to be transmitted.

12. The method of claim 1 also including
adding information in a received information file to the descriptor file, and
adding information from the received information file to the schedule file.

13. The method of claim 12 in which including times in the transmission schedule comprises adding information to the schedule file identifying a subset of a population that should accept the transmitting of the content item.

14. The method of claim 1 in which the set of content items includes one or more of high-resolution video files, low-resolution video files, audio files, images, ringtones, data files, and computer programs.

15. The method of claim 1 also including adding the content item to a position in a queue of content items.

16. The method of claim 15 also including adding to the descriptor file information about each content item's position in the queue, the transmission schedule including information about a next time the queue will be transmitted.

17. The method of claim 16 also including
transmitting descriptor files corresponding to all content items in the queue, and transmitting each content item in the queue in turn.

18. The method of claim 16 also comprising
repeatedly, while transmitting the content items, assigning content items to a next cycle of the queue by doing one or more of
removing a content item in the queue from the next cycle,
adding a new content item not in the queue to the next cycle, and
replacing a content item in the queue with a new content item in the next cycle,
for each new content item, storing information about the new content item and the new content item's position in the next cycle in a description content item corresponding to the new content item,
transmitting the description files corresponding to the content items in the next cycle, and
transmitting each of the content items in the next cycle in turn.

19. The method of claim 17 also comprising transmitting an indication of when transmission of a next cycle of the queue will begin.

20. A method comprising
assigning content items from a set of content items to positions in a queue,
for each content item, storing information about the content item and the content item's position in the queue in a schedule file corresponding to the content item, and
repeatedly,
transmitting the schedule files corresponding to the content items in the queue,
transmitting each of the content items in the queue in turn,
while transmitting the content items, assigning content items to a next cycle of the queue by doing one or more of
removing a content item in the queue from the next cycle,
adding a new content item not in the queue to the next cycle, and
replacing a content item in the queue with a new content item in the next cycle,
for each new content item, storing information about the new content item and the new content item's position in the next cycle in a schedule file corresponding to the new content item,
transmitting the schedule files corresponding to the content items in the next cycle, and
transmitting each of the content items in the next cycle in turn.

21. A method comprising
receiving a file to transmit and information describing the file,
assigning a time in a schedule to transmit the file,
creating a second file from the information describing the file and the assigned time,
transmitting the second file, and
at the assigned time, transmitting the file.

22. The method of claim 21 in which assigning a time comprises assigning the file to a position in a queue of files.

23. The method of claim 21 in which transmitting the file comprises transmitting the queue of files.

24. The method of claim 21 in which the information comprises one or more of a show title, a series title, a category, a type, and a flag.

25. The method of claim 21 in which assigning a time in a schedule comprises
comparing a description of the file to descriptions of files already scheduled,
if a condition is met, removing an already scheduled file from the schedule,
determining the size of the file, a number of times to transmit the file, a time by which the last transmission must be completed, and times available for transmissions in the schedule, and
assigning an available time for a first transmission of the file, and available times for subsequent transmissions of the file.

26. The method of claim 21 in which assigning a time in a schedule comprises
matching the file with files already scheduled,
if a condition is met, removing already scheduled files from the schedule,
determining the size of the file,
assigning the file to a position in a repeating queue of files, and
storing information about the file and its position in the queue in a second file.

27. A method comprising
receiving at a user device a schedule indicating a time when a content item will be transmitted on a one-way channel, and a description of the content item, and
preparing the user device to receive the content item at the time when it is transmitted on the one-way channel.

28. The method of claim 27 also including deleting a stored file on the user device if a condition is met in connection with the transmission of the content item.

29. The method of claim 28 in which the condition is met if a description of a received content item matches a description of the stored file.

30. The method of claim 27 also including maintaining a list on the user device of content items available to be received.

31. The method of claim 30 also including removing a content item from the list if the file has been received.

32. The method of claim 27 also comprising
downloading a first part of the content item at a first time, and
downloading a second part of a content item at a second time.

33. The method of claim 27 also including maintaining a list of content items to be received and times to receive them.

34. The method of claim 27 also including maintaining a list of content items to be received and times to receive them by
receiving a schedule corresponding to a content item,
comparing information in the schedule to information in a subscription policy,
and if a condition is met, adding an identification of the content item and a time to receive the content item to the list.

35. The method of claim 34 also including receiving the schedule at the beginning of a cycle of a queue of content items that includes the content item.

36. The method of claim 34 in which the condition is met if a description of the content item matches a description in the subscription policy.

37. The method of claim 34 in which the condition is met if a description of the content item indicates that the content item is required to be received.

38. The method of claim 33 also including removing a content item from the list after the content item has been downloaded.

39. The method of claim 27 also including maintaining a list of content items that have been received.

40. The method of claim 35 also including periodically determining if a content item has been deleted from storage, and remove such a content item from the list of content items that have been received.

41. The method of claim 39 also including, depending on a condition of a first indicator in the schedule, receiving the corresponding content item, and depending on a condition of a second indicator in the schedule, not adding the content item to the list of content items available to the user.

42. The method of claim 41 also including before presenting a received content item selected by a user, presenting the content item received as a result of the first indicator.

43. The method of claim 42 in which the content item received due to the first indicator comprises an advertisement.

44. The method of claim 27 also including maintaining a unique subscription file for each of one or more users.

45. The method of claim 44 also including displaying to a user
a list of content items available to be received, and
an indication whether a content item in the list is selected to be received.

46. The method of claim 45 also including creating the list of content items by, for each schedule the device has received,
if the schedule includes a category of a corresponding content item, adding the category to the list,
if the schedule includes a series of the corresponding content items, adding the series to the list, and
if the schedule does not include a series of the corresponding content items, adding titles of the content items to the list.

47. The method of claim 27 also including not receiving a content item if a size of the item would cause the device to exceed its capacity.

48. The method of claim 27 also including, when receiving a content item or a description file,
comparing an ID in the content item to an ID in the schedule corresponding to the item, and
if the ID does not match, stopping receiving the file.

49. The method of claim 27 also comprising enabling a user to do one or more of:
view a list of stored items, delete stored items, assign categories to stored items, assign priorities to stored items, and add information about stored items.

50. The method of claim 27 also including enabling a user to specify one or more of
how to store downloaded content items, where to store downloaded content items, how often to receive information about when content items will be transmitted, and a maximum size content item to download.

51. The method of claim 50 in which the user is a user of the device.

52. The method of claim 50 in which the user is a provider of the transmissions.

53. The method of claim 27 also comprising
receiving the schedule during a transmission of a repeating queue of schedules, and
at a time indicated in the schedule, receiving the description file and the content item corresponding to the schedule.

54. The method of claim 53 also including
storing a copy of a schedule that includes a time of a final transmission of a content item, and
when the last transmission has begun, removing the content item from a list of files available to be received.

55. The method of claim 53 also comprising
periodically changing modes to receive schedules in the queue of schedules,
for each schedule in the queue of schedules, comparing information in the schedule to information in a list of items to be received,
if information in a schedule matches information in the list, storing a time when the corresponding content item will be transmitted,
until the stored time, changing modes to conserve power, and
at the stored time, changing modes to receive the corresponding content item.

56. The method of claim 27 also including
receiving an indication of when a repeating queue of content items will start a next cycle,
at the indicated time, receiving schedules for the items that are in the queue, and
at a time indicated in a received schedule, receiving a description file and a content item when they are broadcast as part of the queue.

57. The method of claim 56 also including
periodically changing modes to receive the indication,
until the time when the next cycle will start, changing modes to conserve power,
at the time when the cycle will start, changing modes to receive schedules,
receiving a schedule,
storing a time indicated in the schedule that a content item will be transmitted in the cycle,
until the stored time, changing modes to conserve power,
at the stored time, changing mode to receive a content item, and
after receiving the content item, changing modes to conserve power.

58. A method comprising
for each content item of a set of content items to be transmitted,
including in a transmission schedule a number of times to transmit the content item, the number of times being determined by a provider of the content item, and
preparing the transmission schedule, a descriptor file describing the content item, and the content item for transmitting.

59. A method comprising
for each content item of a set of content items to be transmitted,
including in a transmission schedule a number of times to transmit the content item, the number of times including a final time that is a predetermined amount of time before an expiration time of the content item, and
preparing the transmission schedule, a descriptor file describing the content item, and the content item for transmitting.

60. A method comprising
for each content item of a set of content items to be transmitted,
receiving an information file corresponding to the content item,
including in a transmission schedule a number of times to transmit the content item,
adding information in the information file to a descriptor file describing the content item,
adding other information from the information file to a schedule,
adding the times to transmit the content item to the schedule, and
preparing the schedule, the descriptor file, and the content item for transmitting.

61. A method comprising
for each content item of a set of content items to be transmitted,
receiving an information file corresponding to the content item,
creating a unique identifier corresponding to the content item and information in the information file, and
adding the unique identifier to a descriptor file describing the content item.

62. A method comprising
for each content item of a set of content items to be transmitted,
adding the content item to a position in a queue of content items,
adding the position of the content item in the queue to a schedule,
adding the schedule to a queue of schedules, and
simultaneously transmitting the queue of schedules and the queue of content items.

63. A method comprising
organizing content items to be broadcast to user devices into groups that depend on at least one of the length of the items and the rate at which the items become stale to users of the devices, and
controlling transmission of different groups to the user devices in accordance with different transmission routines.

64. A method comprising
including in a file that contains a content item to be broadcast to user devices a lifetime value that is indicative of when the file is expected to become stale to users of the devices.

65. A method comprising
scheduling a content item for repeated broadcast to user devices, and
establishing a glide interval representing a time after a final broadcast of an item that is sufficiently ahead of a lifetime associated with the content item permit the user to use the content item after receipt of the final broadcast and before the lifetime has expired.

66. A method comprising
updating content items in a recirculating set of content items to be broadcast to user devices while content items in the recirculating set are being broadcast to user devices.

67. A method comprising
transmitting to user devices metadata associated with content items to be transmitted to the user devices, the metadata being transmitted in at least two separate portions, one portion comprising information to enable user devices to determine whether and when to receive one or more of the content items, the other portion containing additional descriptive information about the content items.

68. A method comprising
receiving pieces of a transmitted content item at user devices at different times,
when at least one additional piece must be received in order to have a complete content item, tracking at the user devices a time at which the one additional piece will be transmitted, and
assembling the complete content item at the user devices when all of the pieces have been received, for presentation to the users of the devices.

69. A method comprising
enabling a user device that is configured to receive scheduling information about content items that are to be broadcast at times not controlled by the device, to save power by altering its power mode according to whether a broadcast of a desired content item is occurring.
